(19) United States
(12) Patent Application Publication
(10) Pub. No.: US 2014/0272204 A1
(43) Pub. Date: Sep. 18, 2014

(54) THREE DIMENSIONAL STRUCTURES USEFUL FOR FUNDRAISING AND A METHOD OF FUNDRAISING

(71) Applicant: Christopher Philbrick, Frankenmuth, MI (US)

(72) Inventor: Christopher Philbrick, Frankenmuth, MI (US)

(21) Appl. No.: 13/803,173

(22) Filed: Mar. 14, 2013

(51) Int. Cl. G09F 19/00

(52) U.S. Cl. CPC G09F 19/00
USPC 428/16; 428/33; 428/596; 29/426.1; 700/92

(57) ABSTRACT

Three dimensional structures useful for fundraising. The three dimensional structures can be structured into an interlocking puzzle configuration, can be essentially stacked, or configured in any manner that is stable and will provide a message to potential donors during a fund raising event. A method of fundraising using such blocks is also disclosed.

### BACKGROUND OF THE INVENTION

This invention deals with three dimensional structures useful for fundraising. The three dimensional structures can be structured into an interlocking puzzle configuration, can be essentially stacked, or configured in any manner that is stable and will provide a message to potential donors during a fund raising event.

One means can be found in U.S. Pat. No. 5,377,611, issued Jan. 3, 1995 to Crookham, et al, in which there is disclosed a device and method for visually displaying information relative to donations with respect to a promotional event that includes flags and a display board that can be viewed.

### THE INVENTION

Thus, what is disclosed and claimed herein in one embodiment is a three dimensional structure useful for fundraising The three dimensional structure comprises a multiplicity of hollow building blocks having a predetermined design wherein each block has at least one slotted opening in a wall. The structure is capable of assembly and disassembly by individual blocks.

An additional embodiment is a three dimensional structure as set forth just. Supra, wherein, in addition, there is a visual display associated with the structure to indicate advancement towards a predetermined goal.

Still, another embodiment is a three dimensional structure as as set forth just Supra, wherein the visual display is an Internet display showing accumulation of building blocks towards a predetermined goal.

Another embodiment is a three dimensional structure as set forth just Supra, wherein each said building block has a bar code affixed to it and the bar code identifies a specific location of a building block in the structure.

Finally, there is an embodiment which is a method of fundraising. The method comprises providing a structure as set forth just Supra, of a particular design for a particular client. Thereafter, disassembling the structure into individual building blocks and dispersing the building blocks of the structure throughout a region with a request that funds be deposited in the building blocks in support of said client. Thereafter, retrieving the blocks after a specified period of time and assembling the blocks into the structure as received, to assemble the particular design into the structure. In addition, the method provides a visual display of any funds raised, in association with the structure.

### BRIEF DESCRIPTION OF THE DRAWINGS

FIG. 1A is full side view of a block of this invention.

FIG. 13 is a full top view of a block of this invention.

FIG. 10 is a full end view of a block of this invention.

FIG. 1D is a full bottom view of a block of this invention.

FIG. 2 is a full front illustration of one construction of this invention.

FIG. 3 is a full front illustration of one construction of this invention.

FIG. 4 is a full top illustration of one construction of this invention.

FIG. 5 is a full side illustration of one construction of this invention.

FIG. 6 is a full front illustration of one construction of this invention.

FIG. 7 is a full side illustration of one construction of this invention.

### DETAILED DISCUSSION OF THE INVENTION

Turning now to the invention, and with reference to FIG. 1, there is shown an example of a single segment of this invention in which FIG. 1A is a full side view of a three-dimensional block of this invention. FIG. 1B is a full top view, showing a slot for the deposit of change or bills during the donation phase of the method since the blocks are hollow and act like a piggy bank. FIG. 1C is a full end view of the block, and FIG. 1D is a bottom view of the block. The block can be free-standing, however, it is believed by the inventor herein that the blocks should be interlocking, like, for example, a jigsaw puzzle or Lego block.

The configuration that can be built in this manner can take any form, and it has been found judicious to model a configuration desired by the client that is being served.

For example, as shown in FIG. 2, there is an American flag 2 that is built of interlocking blocks such that the star portion 3 is in the upper left hand corner of the flag, the flag being three dimensional.

FIG. 3 illustrates a farm scene in which there is shown a fence 4, a pig 5, a horse 6, a cow 7, a chicken 8, a haystack 9, a barn 10, a windmill 11, and a tractor 12. The theme for this display could be “build a farm”. FIG. 4 is full top view of the illustration shown in FIG. 3 wherein like numbers have like designations. Thus, the “building blocks” would be the farm animals, the farm buildings and haystack, and the like.

FIG. 5 illustrates a bridge 13 for a theme such as “build a bridge” and the building blocks would be the segments of the structure of the bridge.

FIG. 6 illustrates a house 14, for a theme such as “build a house” and the building blocks would be the bricks of the house, for example.

FIG. 7 illustrates a car 15, for a theme such as “build a car”. Almost any configuration can suffice for this invention.

Another embodiment of this invention is a method of fundraising, the method comprises providing a structure configured as set forth Supra, of a particular design for a particular client. The configuration is disassembled into individual building blocks and the building locks are dispersed through a region, neighborhood, or city in which the funds are to be raised. The building blocks would normally be displayed in businesses, public places, and the like, along with literature and the like and a request that funds be deposited in the building blocks in support of said client.

After a predetermined time, the blocks are retrieved and they are retrieved, they are reassembled into the configuration. The progress of the fundraising can easily be determined from viewing the partially built configuration and when all of the blocks are in place, the project is finished. It is contemplated within the scope of this invention to provide a visual display, such as an internet display, showing accumulation of building blocks towards the predetermined financial goal. Such a display can be a two dimensional thermometer or the like.

Also contemplated within the scope of this invention is the use of bar code labeling so that it would be easy to track the block and place it in the configuration when re-assembling the configuration. In addition, the block could be traced to an individual client and fund raiser. The blocks are re-useable and can be used in many fundraising activities.

What is claimed is:

1. A three dimensional structure useful for fundraising, said three dimensional structure comprising:
a. a multiplicity of hollow building blocks having a predetermined design;
b. each said block having at least one slotted opening in a wall;
c. said structure being capable of assembly and disassembly by individual block.

2. A three dimensional structure as claimed in claim 1 wherein said building blocks are interlocking.

3. A three dimensional structure as claimed in claim 2 wherein said structure is an interlocking puzzle.

4. A three dimensional structure as claimed in claim 1 wherein the design is a flag.

5. A three dimensional structure as claimed in claim 1 wherein the design is a U.S. flag.

6. A three dimensional structure as claimed in claim 1 wherein the design displays a farm.

7. A three dimensional structure as claimed in claim 1 wherein the design displays a farm animal.

8. A three dimensional structure as claimed in claim 1 wherein the design displays a bridge.

9. A three dimensional structure as claimed in claim 1 wherein the design displays a building.

10. A three dimensional structure as claimed in claim 1 wherein the design displays a herd of animals.

11. A three dimensional structure as claimed in claim 1 wherein the design displays a flock of birds.

12. A three dimensional structure as claimed in claim 1 wherein each building block is manufactured from plastic.

13. A three dimensional structure as claimed in claim 12 wherein the plastic is polyethylene.

14. A three dimensional structure as claimed in claim 12 wherein the plastic polypropylene.

15. A three dimensional structure as claimed in claim 1 wherein each building block is manufactured from wood.

16. A three dimensional structure as claimed in claim 1 wherein each building block is manufactured from metal.

17. A three dimensional structure as claimed in claim 16 wherein the metal is aluminum.

18. A three dimensional structure as claimed in claim 1 wherein, in addition, there is a visual display associated with the structure to indicate advancement towards a predetermined goal.

19. A three dimensional structure as claimed in claim 18 wherein the visual display is an internet display showing accumulation of building blocks towards a predetermined goal.

20. A three dimensional structure as claimed in claim 18 wherein the visual display is a replica of a thermometer.

21. A three dimensional structure as claimed in claim 1 wherein each structure displays a title.

22. A three dimensional structure as claimed in claim 1 wherein each said building block has a bar code affixed to it.

23. A three dimensional structure as claimed in claim 1 wherein the bar code identifies a specific location of a building block in the structure.

24. A method of fundraising, said method comprising providing a structure as claimed in claim 1 of a particular design for a particular client;
disassembling the structure into individual building blocks;
dispersing the building blocks of the structure throughout a region with a request that funds be deposited in the building blocks in support of said client;
retrieving said blocks after a specified period of time and assembling said blocks into the structure as received, to assemble said particular design into said structure.

25. The method as claimed in claim 24 wherein, in addition, there is provided a visual display of any funds raised, in association with the structure.
